(19) United States
(12) Patent Application Publication
(10) Pub. No.: US 2013/0343608 A1
(43) Pub. Date: Dec. 26, 2013

(54) INFORMATION DEVICE

(71) Applicant: Audi AG, Ingolstadt (DE)

(72) Inventor: Michael BÄR, Ingolstadt (DE)

(21) Appl. No.: 13/921,822

(22) Filed: Jun. 19, 2013

(30) Foreign Application Priority Data
Jun. 20, 2012 (DE) 10 2012 012 269.1

(51) Int. Cl. G01C 21/26

(52) U.S. Cl. CPC G01C 21/26
USPC 382/103

(57) ABSTRACT

An information system for a motor vehicle includes a translation aid incorporated in a navigation system. The translation aid can transform a text of a first script system into a second script system. A motor vehicle with such an information system and a method for using such information system are also disclosed.

### CROSS-REFERENCES TO RELATED APPLICATIONS

This application claims the priority of German Patent Application, Serial No. 10 2012 012 269.1, filed Jun. 20, 2012, pursuant to 35 U.S.C. 119(a)-(d), the content of which is incorporated herein by reference in its entirety as if fully set forth herein.

### BACKGROUND OF THE INVENTION

The present invention relates to an information device for providing information to an occupant of a motor vehicle, to a motor vehicle with such information device, and to a method for informing an occupant of a motor vehicle.

The following discussion of related art is provided to assist the reader in understanding the advantages of the invention, and is not to be construed as an admission that this related art is prior art to this invention.

Vehicles are increasingly equipped with navigation systems that facilitate the navigation of the vehicle. Modern navigation systems can display, in addition to a mere representation of directional information, also traffic signs on their output units, e.g. a display screen. The vehicles are equipped with a camera and the navigation systems are equipped with sign or text recognition, so that current information from a road boundary can be provided to the vehicle operator on the screen. This can increase traffic safety when the driver has either not seen a sign or has forgotten the sign after a while, since the sign remains displayed on the screen for as long as the vehicle is staying within the coverage area of the sign.

Furthermore, navigation systems are equipped with a wide variety of different maps, so that the vehicle with the navigation system is not limited to a single country, usually its home country. However, this poses a problem for a driver in that he may not be not conversant in the respective language and may thus be unable or only be barely able to read the road and traffic signs. In countries where the language is similar to the language of the driver's home country, street signs or their meaning can still be inferred.

However, there is still a significant problem for a driver in those countries that use a different script. For example, a Western European driver may still recognize individual letters on road signs; however, he may no longer be able to interpret the road signs when traveling to Eastern Europe, for example to Bulgaria or Greece, because he may be unable to interpret the local alphabet.

It would therefore be desirable and advantageous to obviate prior art shortcomings and to provide an improved information system of a motor vehicle and to provide a driver with a traffic guidance function in his navigation system, which enables him to reliable find his way around in foreign countries.

### SUMMARY OF THE INVENTION

According to one aspect of the present invention, an information device for informing at least an occupant of a vehicle is proposed, which includes a navigation device with an image recognition unit for recognizing a street sign and a transformation unit, wherein the navigation device is capable of recognizing a text or symbol of a first script system visible on the road sign and the transformation unit is capable of transforming the recognized script into a second script system. In particular with street signs in the form of a traffic sign that include text, a person not versed in the particular script is unable to unambiguously infer its meaning from the sign, and the navigation system is therefore equipped with a translation aid. Here, the term “script system” not only refers to a script such as Latin, Arabic, Chinese script or the like, but also to a language written with this script. Different languages can be written in the Latin alphabet, such as German, English or French. The alphabets used for these languages are not uniform, so that characters of different languages derived from the corresponding basic alphabet are also included in the script system.

According to an advantageous feature of the present invention, the street sign may be a traffic sign, which preferably has a text or a symbol of the first script system, wherein the transformed text or the symbol can be displayed in the output unit, especially the navigation system. The image recognition unit may be configured to recognize traffic signs on the side of the road. The text or a symbol on the traffic sign is then identified, which may be associated with the first script system. The transformed text may be displayed on a display or a head-up display.

According to another advantageous feature of the present invention, the transformed text may be displayed in the output unit in the area of the identified road sign that is displayed in the output unit. The correlation between the text and the traffic sign is vital for the driver, so that, on one hand, the traffic sign is shown on the display and, on the other hand, the translation is presented in such a way that the viewer of the display detects the correlation between the recognized signs and the translated text.

According to another advantageous feature of the present invention, the detected traffic signs may be displayed as a traffic sign that has the text in the first script system, but now equivalent to a traffic sign or symbol of the second script system. Traffic signs of the first script system may be represented as traffic signs of the transformed text. Not only may the text on road signs be incomprehensible to the driver, but also its overall significance, because the traffic sign may not correspond to the familiar sign in the home country. Therefore, the sign may be adapted to the equivalent and known traffic signs in conjunction with a simultaneous display the translated text.

According to another advantageous feature of the present invention, the text may have at least a character, a letter and/or a number or a plurality of characters, letters and/or numbers. In other words, the text may not be formed exclusively from several letters or characters, but also only from one letter, one number or one character. Several words or a sequence of individual letters or characters are also feasible.

According to another aspect of the invention, a vehicle has an information device for providing information to at least an occupant of a motor vehicle, wherein the information device includes a navigation system having an image recognition unit configured to recognize a road sign having a text or a symbol in a first script system, and a transformation unit configured to transform the text or a symbol into a second script system. When a motor vehicle has an information device capable of translating an unknown script, it is easier for the driver to orient himself in the particular country.

According to yet another aspect of the invention, a method for providing information to at least one occupant of a motor vehicle includes recognizing with a navigation device at least one road sign having a text or a symbol in a first script system, and transforming with a transformation unit the text or a symbol into a second script system.

According to an advantageous feature of the present invention, the transformation unit may include an online query via a central memory for transforming the text or symbol. The online query allows the information device to flexibly request the latest data, wherein basic information may be stored in the internal memory of the navigation system.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic diagram of an exemplary embodiment of an information device according to the present invention;

### DETAILED DESCRIPTION OF PREFERRED EMBODIMENTS

The depicted embodiment is to be understood as illustrative of the invention and not as limiting in any way. It should also be understood that the figure is not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

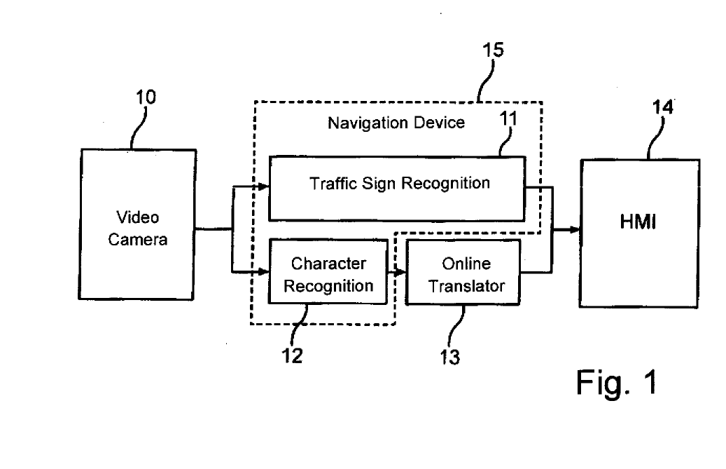

Turning now to the drawing, there is shown in FIG. 1 an information device according to the exemplary embodiment of the invention integrated in a motor vehicle which has a navigation system or a navigation device 15. An image recognition unit is associated with the navigation device 15, so that road signs and traffic signs can be recognized by the information device and read into the system. Such an additional function of a navigation system 15 is known per se, and its operation will therefore not be separately discussed here. It is known to the expert to use a camera 10 for this purpose which detects an area in front of the vehicle.

The camera 10 of the exemplary embodiment captures the surroundings of the vehicle via video capture, wherein in a next step objects in the recorded images are segmented. If it is determined that a traffic sign or road sign or generally a road sign has been captured by the camera 10, text recognition is performed in a further step by, on one hand, determining whether a text is integrated in the sign and, on the other hand, what the semantic meaning of the text is.

To determine the meaning of the text, character recognition 12 is performed first by determining the script type in the text in the traffic sign. This determination may also be preset by having the driver manually set the script type or the language for the country in which the vehicle is currently located, in which case the information device then no longer has to perform the step of character recognition 12 because a processing unit is already programmed to the corresponding script.

In the character recognition 12, the arithmetic unit of the navigation device determines, whether the script attached on the traffic sign has, for example, Latin, Cyrillic, Greek, Hebrew, Arabic characters. In addition, Japanese, Chinese or Korean characters may be recognized by the computer as well as script from the Indian subcontinent and many other types of script. The information device is programmed for different script systems.

After character recognition 12, the actual text recognition is performed by identifying the recognized characters as text with a message. When the driver drives his vehicle in his home country, the text is shown for example on an output unit 14 associated with the navigation system 15, wherein such human-machine interface (HMI) is integrated in the form of a display screen or a head-up displays in the vehicle. Conversely, when the driver is not traveling in his home country, but in a country where another script system prevails, the computer determines, as described above, that different characters are placed on road signs.

These characters can be translated or transformed by the computer into a script that is readable and understandable for the driver. For this purpose, an online translator 13 is provided, in which the navigation system 15 transmits online the recognized text of a first script system to a central computer, which transforms the text into a second script system that the driver can understand. To conserve processing power in the navigation system, the transformation from a first script to a second script is typically performed online via a central computer located inside or outside the vehicle. The transformation may also be performed in the computing unit in the navigation system 15, which then stores several different script systems for this purpose.

For text recognition, the traffic sign is also recognized by the computer, wherein the recorded traffic signs are compared by a symbol memory, in which the road signs for different countries are saved. The translation or transformation of the recognized text can optionally be shortened or verified by using the traffic sign recognition 11. For example, when a one-way street sign was detected by the traffic sign recognition 11, with the text “One Way Street” included on the sign, the text recognition does not need to transform the word “One Way Street”, so that the one way traffic sign can be more quickly displayed on the output unit.

The sign recognition 11 can therefore be carried out in parallel with or before the text recognition. The traffic sign recognition 11 is to be distinguished from the first step described above, namely that a traffic sign is present. The road sign is detected only in a separate step using the symbol memory. A verification can thus be carried out with the traffic sign recognition 11, namely when the traffic sign recognition 11 has determined the traffic sign “One Way Street” and the text recognition has correctly transformed the text “One Way Street” from a first script system into a second script system.

FIG. 1 shows a schematic diagram of the invention, wherein traffic signs are recorded with a video camera 10 and the traffic signs are subjected, on one hand, to a traffic sign recognition 11 and, on the other hand, to a text and character recognition 12. The traffic sign recognition 11 and the character recognition 12 are part of the navigation device 15. The transformation of the text or the characters is performed online, for example by a query to a central computer. The central computer is preferably located outside the vehicle, so that the query may be performed via an Internet connection. The online translator 13 described in the figure is therefore typically not integrated in the vehicle. Once the navigation device has received the translated or transformed text, the transformed text is displayed on a display unit (HMI) 14.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An information device for providing information to at least an occupant of a motor vehicle, comprising:
a navigation system having an image recognition unit configured to recognize a road sign having a text or a symbol in a first script system, and
a transformation unit configured to transform the text or a symbol into a second script system.

2. The information device of claim 1, wherein the road sign is a traffic sign that includes the text or symbol of the first script system, and further comprising an output unit for displaying the transformed text or symbol.

3. The information device of claim 2, wherein the output unit is part of the navigation system.

4. The information device of claim 2, wherein the transformed text is displayed in the output unit in an area of the recognized road sign that is concurrently displayed in the output unit.

5. The information device of claim 1, wherein the recognized road sign having the text or symbol of the first script system is displayed as a traffic sign, with the displayed traffic sign corresponding to a traffic sign of the second script system.

6. The information device of claim 1, wherein the text is at least one of a symbol, a letter and a number.

7. The information device of claim 6, wherein the text comprises a plurality of symbols selected from characters, letters and numbers.

8. A motor vehicle with an information device for providing information to at least an occupant of a motor vehicle, wherein the information device comprises a navigation system having an image recognition unit configured to recognize a road sign having a text or a symbol in a first script system, and a transformation unit configured to transform the text or a symbol into a second script system.

9. A method for providing information to at least one occupant of a motor vehicle, comprising:
recognizing with a navigation device at least one road sign having a text or a symbol in a first script system, and
transforming with a transformation unit the text or a symbol into a second script system.

10. The method of claim 9, wherein for transforming the text or the symbol, the transformation unit performs an online query via a central memory.
